(19) United States
(12) Patent Application Publication
(10) Pub. No.: US 2017/0074588 A1
(43) Pub. Date: Mar. 16, 2017

(54) VACUUM FURNACE WITH HEATING VESSEL IN MULTIPLE ORIENTATIONS AND METHOD THEREOF

(71) Applicant: T-M Vacuum Products, Inc., Cinnaminson, NJ (US)

(72) Inventors: Fred Thompson STUFFER, Marlton, NJ (US); Scott Steven FORRESTER, Cheltenham, PA (US); Kennard Merrill CHEW, JR., Medford, NJ (US)

(21) Appl. No.: 14/851,438

(22) Filed: Sep. 11, 2015

(51) Int. Cl. F27D 7/06

(52) U.S. Cl. CPC F27D 7/06; F27D 2007/066

(57) ABSTRACT

A vacuum furnace comprises a vessel having a door, a plurality of heating elements within the vessel, a vacuum system for evacuating an interior of the vessel, and a pivoting member for pivoting the vessel between a first position where the door when closed is facing substantially upward, and a second position where the door when closed is facing away from substantially upward. In a method of enabling heating a vacuum furnace, the vessel is able to pivot between two positions. In a method of operating a vacuum furnace, the vessel pivots between two positions.

### FIELD OF INVENTION

This present invention relates to vacuum furnaces and more particularly to vacuum furnaces with heating vessels which operate in multiple orientations. Specifically, a vacuum furnace is disclosed with a heating vessel which is movable between a horizontal operational position and a vertical operational position.

### BACKGROUND OF THE INVENTION

Vacuum furnaces are known for being able to subject different types of work pieces to a high level of heat. For example, a typical vacuum furnace is able to expose a work piece to a temperature between 600 degrees Fahrenheit and 3000 degrees Fahrenheit. Operation of a vacuum furnace typically begins by opening the door to the furnace. An exemplary vacuum furnace is disclosed in U.S. Application 2002/0126729 which is hereby incorporated by reference. After a work piece is inserted into the vacuum furnace, the door to the vacuum furnace is closed and a vacuum pump is operated. A vacuum pump removes air and any other gases from the interior of the vacuum furnace and thus creates a vacuum. Once the vacuum has been created, the work piece is subjected to radiant heat (as opposed to convection heat).

Vacuum furnaces are known for being able to provide uniform heating temperature to the work piece which has been placed inside the vacuum furnace. Furthermore, the work piece is prevented from being contaminated by virtue of the fact that the work piece is being heated in a vacuum.

After any gases inside the vacuum furnace have been pumped out and the inside of the vacuum furnace is in a vacuum state, a plurality of heating elements which surround the work piece are energized (i.e. electric current is passed through the heating elements) in order to generate heat. Exemplary heating elements are made from tungsten, molybdenum, or other materials. Furthermore, exemplary heating elements are described in U.S. Application 2013/0175256 which is hereby incorporated by reference.

After the work piece has been heated for a period of time, the work piece is then allowed to cool. Cooling of the work piece may be initiated by ceasing to energize the heating elements (by, for example, ceasing to provide electricity to the heating elements). Furthermore, a gas (such as an inert gas) may be introduced into the vacuum furnace to facilitate cooling. This process is called quenching. By causing the heating elements inside the vacuum furnace to generate heat in a vacuum environment, various different industrial processes may be accomplished including brazing, sintering, and heat treatments.

Vacuum furnaces typically have several common components and the basic structure thereof is known in the art as evidenced by U.S. 2007/0069433, U.S 2004/0007565, and U.S. 2003/0160088, all of which are incorporated by reference for their teachings in the art of vacuum furnaces.

Typically, a vacuum furnace is in a cylindrical shape with a door which is opened to allow insertion of the work piece, and closed to allow the work piece to be heated in a vacuum environment. Inside the cylinder, a plurality of heating elements are arranged. Assuming an axis extending lengthwise through a center of the cylinder, the heating elements may be arranged around the axis. As illustrated for example in U.S. 2002/0126729, FIG. 5, heating elements may be arranged around the axis described above. Between the heating elements and the outer cylinder wall of the vacuum furnace, heat shielding may be used. Exemplary heat shields are illustrated as item 48 in FIG. 5 of U.S. 2002/0126729. The heat shields may be a heat reflecting assembly which is formed of a plurality of nested concentric shields which are made of a material which may include, for example, molybdenum.

The outer wall of the cylindrical portion of the vacuum furnace may be heat insulated simply by providing a wall (which includes graphite, for example) of high thickness and low thermal conductivity. Alternatively, the cylinder which comprises the vacuum furnace may be liquid cooled. Various techniques are known in the art of vacuum furnaces for liquid cooling. For example, U.S. 2002/0126729, FIG. 5 discloses channel E in which fluids are presented. U.S. 2003/0160088 describes a furnace cooling system.

Other components of a vacuum furnace include a door which includes a hinging mechanism for facilitating opening and closing of the door. Furthermore, some type of lock or clamping mechanism is desirably provided in order to secure the door closed while the vacuum furnace is in operation. The door may also include a window which allows an operator to be able to look through the window and see inside the vacuum furnace while the vacuum furnace is operating.

A vacuum pump (or multiple pumps) is used for evacuating air (or other gases) from the furnace before the heating elements are energized.

A quenching system may also be included. The quenching system allows some type of gas, such as an inert gas, to be introduced into the vacuum furnace after the heating elements are no longer supplying heat. The quenching system may include, for example, bottled (compressed) gas and a recirculating fan. Again, the introduction of these gases facilitates cooling of the interior of the vacuum furnace.

A hearth is also provided. A hearth is some type of structure on which the work piece is placed while the vacuum furnace is heating the work piece. A hearth may comprise a plurality of legs which are positioned to extend orthogonally from the inner surface of the vacuum chamber. A member, which is typically a horizontal member, is then supported on the legs. The work piece is then placed on the member. The member may be a flat support (e.g., in a square or rectangular shape) or it may have a bar configuration supported at opposite ends by two projecting members extending orthogonally from the inside wall of the vessel. The components of the hearth are typically made of molybdenum.

### SUMMARY OF THE INVENTION

A vacuum furnace comprises a vessel having a door, a plurality of heating elements within the vessel, a vacuum system for evacuating an interior of the vessel, and a pivoting member for pivoting the vessel between a first position where the door when closed is facing substantially upward, and a second position where the door when closed is facing away from substantially upward. In an exemplary embodiment of the present invention, one of the positions is a vertical position while another of the positions is a horizontal position. In a method of enabling heating a vacuum furnace, the vessel is able to pivot between two positions. In a method of operating a vacuum furnace, the vessel pivots between two positions.

### BRIEF DESCRIPTION OF THE FIGURES

FIG. 1 is a perspective view of a vacuum furnace with an exemplary of the present invention. In FIG. 1, the vacuum furnace is in a horizontal configuration.

FIG. 2 is a further perspective view of an exemplary embodiment of the present invention. In FIG. 2, the vacuum furnace is in a vertical configuration.

FIG. 3 is a sectional side view of a pivot mechanism which allows the vacuum furnace to be oriented in a vertical or horizontal configuration in accordance with an exemplary embodiment of the present invention.

FIG. 4 is a sectional side view, which includes a cooling liquid routing schematic, of a vacuum furnace in a horizontal configuration in accordance with an exemplary embodiment of the present invention.

FIG. 5 is a sectional side view, which includes a cooling liquid routing schematic of a vacuum furnace in a vertical configuration in accordance with an exemplary embodiment of the present invention.

FIG. 6 is an interior view of several components which may be found in a vacuum furnace in accordance with an exemplary embodiment of the present invention.

FIG. 7 is a perspective view of a hearth in accordance with an exemplary embodiment of the present invention when the vacuum furnace is in a vertical orientation.

FIGS. 8 and 9 are side and front views, respectively, of a hearth in accordance with an exemplary embodiment of the present invention when the vacuum furnace is in a horizontal orientation.

### DETAILED DESCRIPTION OF THE INVENTION

Basic operation of an exemplary vacuum furnace comprises the steps of opening the door of a vacuum furnace, inserting a work piece on a hearth within the furnace, closing the door and securing the door closed, evacuating most gas from the inside of the vacuum furnace, energizing the heating element inside the vacuum furnace in order to provide heat to the work piece, de-energizing the heating elements and cooling the inside of the vacuum furnace, opening the door, and removing the work piece.

Vacuum furnaces come in various sizes and configurations. A desirable size and configuration for heating a work piece is dependent upon the size and shape of the work piece. For example, if the length of the work piece is greater than the height of the work piece, a horizontal configuration of the vacuum furnace is desirable. When the phrase “horizontal configuration” is used, what is intended is a configuration by which the work piece is inserted into the vacuum furnace by moving the work piece with a first motion (i.e. horizontal motion). In this configuration, for example, the door of the vacuum furnace is facing horizontally, towards the side of the furnace, and the door is opened and closed to enable horizontal access to the inside of the vacuum furnace. Put another way, assume that the cylindrical chamber which comprises the vacuum furnace is arranged so that an axis extending along the length of the cylinder (and, for example, extending through the center of the cylinder) is in a horizontal orientation. Put another way, in the horizontal orientation, the door of the vacuum furnace is facing away from a substantially upward direction. Rather, the door is facing toward the side of the vacuum furnace.

In the vertical configuration, the door of the vacuum furnace is facing substantially upward. In this configuration, a work piece is inserted into the vacuum furnace by being placed into the vacuum furnace from above the vacuum furnace. Its axis extending along the length of the cylinder that comprises the vacuum furnace is oriented in a vertical direction.

Another way to think of a horizontal configuration and a vertical configuration is that entry into the cylindrical member which comprises the vacuum furnace occurs from two respectively different directions.

In accordance with an exemplary embodiment of the present invention, the vacuum furnace is able to move (or be moved) between a vertical configuration and a horizontal configuration. The ability to move the vacuum furnace between the vertical and horizontal configurations has been found to be desirable, because such movement allows the vacuum furnace to be operated in either the vertical or horizontal configuration. By thus enabling the vacuum furnace to operate in a vertical or horizontal configuration, the vacuum furnace is able to accommodate types of work pieces which may not be accommodated by a vacuum furnace which is in only a horizontal configuration or a vertical configuration.

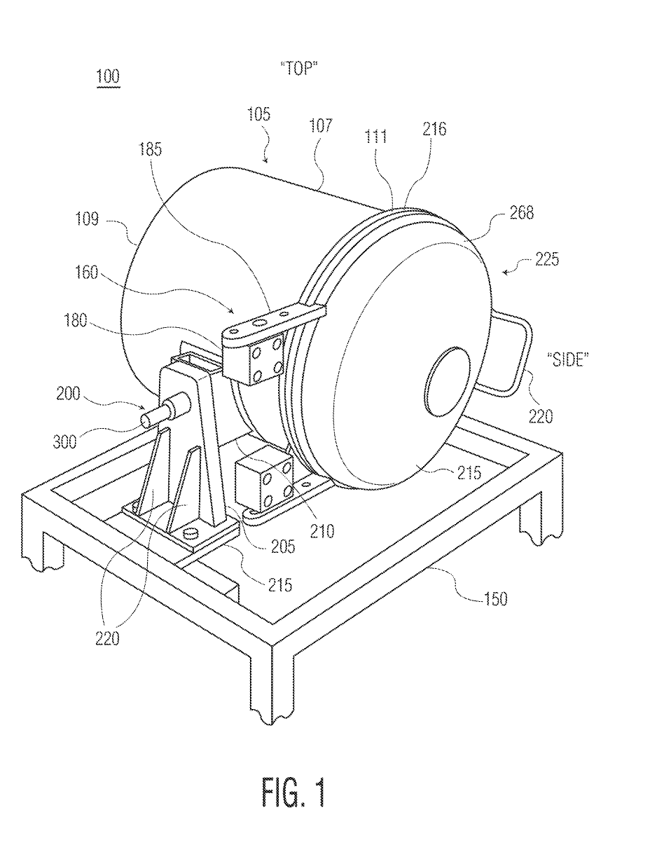

FIG. 1 is a perspective drawing of a vacuum furnace in accordance with an exemplary embodiment of the present invention. The vacuum furnace in FIG. 1 is in a horizontal configuration and the door, when closed, is facing away from being substantially upwards.

As shown in FIG. 1, the frame 150 is included on which the vacuum furnace is supported. Frames may have a variety of different configurations and the frame shown in FIG. 1 is merely exemplary.

Vessel 105 includes cylinder 107 in which the heating elements are located and at which the work piece (not shown) receives vacuum heat treatment. Vessel 105 includes an end 109 opposite to the end of vessel 105 where door 225 is located. A vessel rim 111 is situated along the outer end of cylinder 107. Door 225 is tightly sealed against vessel rim 111 when vacuum furnace 100 is in use. As is known to one of ordinary skill in the art, door 225 may include a locking mechanism (not shown) for securing door 225 to cylinder 107. A window (not shown) allows an operator to look inside vessel 105 while the work piece is being heated within vessel 105. Door 225 includes door hinge 160. Door hinge 160 is comprised of hinge member 185 which is secured to door 225 and hinge block 180 which is secured to rim 111. Thus, in order to facilitate the opening and closing of door 225, door 225 along with hinge member 185 may rotate relative to hinge block 180 which is fixed relative to rim 111. A hinge pin (not shown) may be used for coupling hinge member 185 and hinge block and for allowing rotational motion of hinge member 185 relative to hinge block 180.

Handle 220 may also be included. By pulling on handle 220, it is possible to open and close door 225.

Door 225 includes door section 215 and door rim 216. Door section 215 includes side section 268. Door rim 216 may include a seal (not shown) for enabling an airtight seal between door 225 and vessel 107 when vacuum furnace 100 is in use.

Pivot member 200 is located, for example, along a side of vessel 107 and pivot member 200 may be secured to frame 150. Pivot member 200 includes a pivot base 215 which, for example, provides a horizontal surface and which is coupled to frame 150. Pivot bracket 205 may extend vertically from pivot base 215. Reinforcement members 220 may help to support pivot bracket 205 relative to pivot base 215.

Pivot support 210 is rigidly attached to vessel 107. Pivot support 210 is also rigidly attached to pivot pin member 300. Thus, as pivot pin member 300 rotates, pivot support 210 rotates with pivot pin member 300. Furthermore, as pivot support 210 rotates, vessel 105 also rotates

FIG. 1 illustrates vessel 105 in a first position where the door is closed and facing away from being substantially upwards. Thus, for example, in the first position, the door may be facing towards a “side” of the figure (as opposed to, for example, facing the “top” of the figure), or, so that horizontal access to the interior of vacuum furnace 100 is available (as illustrated, for example, in FIG. 1).

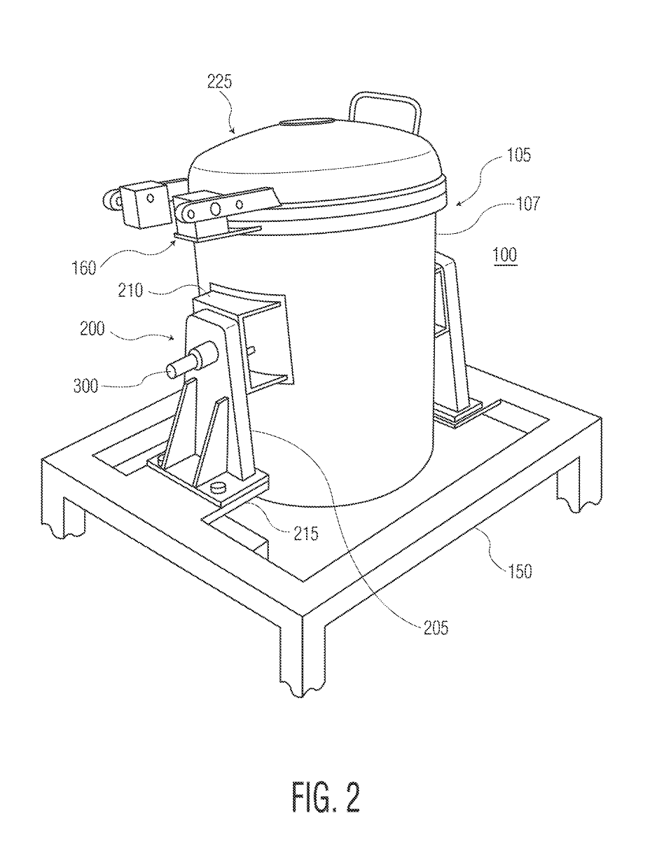

FIG. 2 is an exemplary embodiment of the present invention in which vessel 105 has been rotated into a vertical position. Put another way, vessel 105 has been rotated into a direction away from a horizontal position, or vessel 105 has been rotated to be in a direction different than the direction illustrated, for example, by FIG. 1. In the exemplary embodiment shown in FIG. 2, vessel 105 has been rotated to a position where door 225 is facing substantially upwards. Thus, FIG. 2 is illustrating vessel 105 in a first position where the door, when closed, is facing away from the position illustrated in FIG. 1. As shown in FIG. 2, because pin 300 has been rotated from the position it was in in FIG. 1, pivot support 210 has also been rotated. Because pivot support 210 has been rotated, vessel 105 has been rotated and door 225 is facing substantially vertically.

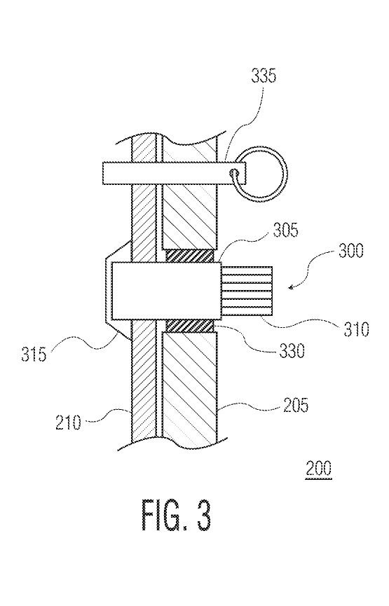

FIG. 3 is a sectional view of pivot member 200. Pivot bracket 205 includes an opening in which pivot pin member 300 is inserted. Pivot pin member 300 may include a round section 305, and keyed section 310. Keyed section 310 is configured to receive a handle (not shown) with an opening that engages keyed section 310. FIG. 3 illustrates keyed section 310 as a male member which engages a female member at the end of a handle. It is understood, however, that keyed section 310 can be replaced with a female member which receives a male member of a handle. The handle may be a pole-like member with a right angle bend. Thus, manipulation of the handle cause keyed section 310 to turn which causes pivot pin 300 to turn. Round section 305 is situated within the opening within pivot bracket 205. Bushing 330 is located within the opening in pivot bracket 205 and round section 305 is located within bushing 330. Round section 305 extends through bushing 330 and pivot support 210. The end of round section 305 opposite to the end of round section 305 facing keyed section 310 emerges from the opening in pivot support and is attached to pivot support 210 with, for example, weld joint 315. Thus, rotation of keyed section 310 causes pivot support 210 (along with vessel 105) to move.

The manner of securing pin 300 to pivot support 210 described above and shown in FIG. 3, is merely exemplary, and one of ordinary skill in the art will know of other ways of rigidly securing pivot pin member 300 to pivot support 210.

Pin 335 is also shown. Pin 335 is able to extend through holes which line up in pivot bracket 205 and pivot support 210 in order to prevent rotation of vessel 105. Thus, pivot support 210 may include two holes for receiving pin 335; a first hole in pivot support 210 for receiving pin 335 while vessel 105 is in a horizontal configuration, and a second hole in pivot support 210 for receiving pin 335 while 105 is in a vertical (non-horizontal) configuration. Further, multiple pins 335 with respective multiple holes may be included. Insertion of pin 335 is desirable for preventing rotation of vessel 105 while vacuum furnace 100 is heating a work piece.

The location of the axis about which vessel 105 rotates may be arbitrary, or it may be specifically chosen. One exemplary location of the axis about which vessel 105 rotates is at the center of gravity of vessel 105. This may be helpful if vessel 105 is large and heavy in order to facilitate rotation of vessel 105. Alternatively, the axis about which vessel 105 rotates may be chosen with ergonomic purposes in mind, i.e. in order for door 225 to be a location that facilitates entry of a workpiece into vessel 105.

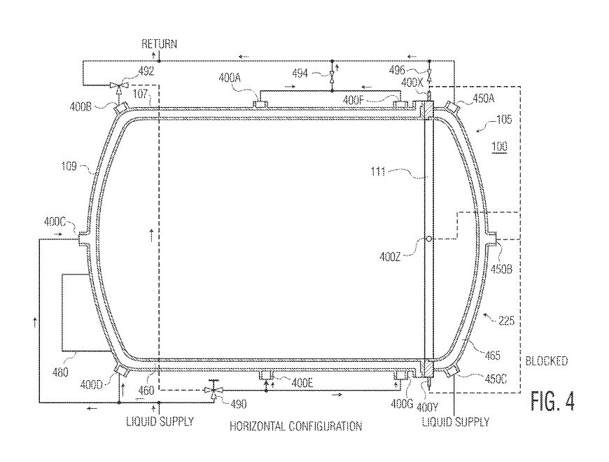

FIG. 4 is a side sectional view of vessel 105 in a horizontal configuration. FIG. 4 illustrates that the outer walls that comprise cylinder 107 and door 225 may be hollow. In other words, the outer walls of cylinder 107 and door 225 include inside channel 460, 465, respectively. The purpose of inside channel 460, 465 is to allow a liquid such as water to flow through. The purpose of allowing liquid to flow through channels 460, 465 is to cool the exterior of vessel 105.

As shown in FIG. 4, a plurality of liquid couplings 400A, B, C, D, E, F and G are included with cylinder 107. In addition, liquid couplings 400X, Y and Z may be included in rim 111 of vessel 105. The purpose of liquid couplings 400A through G is to allow liquid to be introduced into and removed from channel 460. While liquid couplings 400X, Y and Z also include a pathway to channel 460, liquid couplings 400X, Y and Z are typically used for allowing liquid to leave channel 460. Liquid (i.e. chilled liquid) is introduced into at least one of liquid couplings 400A through G and is removed from channel 460 through at least another of liquid couplings 400A through G (and possibly through couplings 400X, Y and Z). Liquid couplings 400A through G are illustrated merely as examples of liquid couplings and it is possible that more or fewer liquid couplings may be included, and at various locations.

Similarly, door 225 includes inside channel 465. Liquid couplings 450A, B and C are included for introducing liquid into and removing liquid from inside channel 465. At least one of liquid couplings 450A, B, C may be used for introducing liquid into inside channel 465 and at least another of liquid couplings 450A, B, C may be used for removing liquid from inside channel 465.

In operation, liquid that is introduced into inside channels 460 and 465 becomes hot by virtue of the heat which is generated inside vessel 105. After the liquid leaves inside channels 460, 465, the liquid may be cooled and then reintroduced into inside channels 460, 465. In this manner, the outside temperature of vessel 105 can be maintained at a safe temperature, i.e., a temperature which will not inflict harm if an operator touches the outside of vessel 105.

In an exemplary embodiment of the present invention, it is desirable to introduce liquid into inside channels 460, 465 through liquid couplings which are substantially towards or at the bottom of vessel 105. In that exemplary embodiment, liquid is removed from inside channel 460, 465 through liquid couplings which are substantially towards or at the top of vessel 105. The meaning of the words “bottom” and “top”, however, will change depending upon whether vessel 105 is in a vertical orientation or a horizontal orientation. Regardless, the reason why liquid is introduced at the bottom and removed from the top is to ensure that inside channels 460, 465 are full of liquid. Thus, liquid is permitted to completely fill inside channels 460, 465 and then to flow out through the top of vessel 105. To put it another way, if liquid is introduced through the top of vessel 105, the liquid may descend by gravity and not all areas of inside channels 460, 465 may be uniformly full of liquid. However, by introducing the liquid to vessels 460, 465 through the bottom, it is much easier to maintain inside channel 460, 465 completely and uniformly full of liquid.

In practice, water flows from a liquid supply, through channels 460, 465, and to a liquid return. The temperature of the water at the liquid return is higher than the temperature of the liquid at the liquid supply. Thus, after the liquid reaches the liquid return, the temperature of the liquid is reduced (i.e. through chilling) and the water is then returned to the liquid supply so it can be again circulated through channels 460, 465.

Thus, depending upon the orientation of vessel 105, some liquid couplings may be used for introducing liquid into inside channel 460, 465 and other liquid couplings may be used for allowing liquid to leave inside channel 460, 465. For this reason, valves 490, 492, 494 and 496 are included. In the configuration shown in FIG. 4, valve 490 is allowing liquid to flow into channel 460 through liquid coupling 400G. However, valve 490 is preventing liquid from flowing into valve 492. Instead, valve 492 is allowing liquid to flow out of liquid coupling 400B into the liquid return. Furthermore, in the orientation shown in FIG. 4, valve 494 is permitting liquid to flow out of liquid couplings 400A, F and towards the liquid return. Liquid is flowing into inside channel 460 via liquid couplings 400C, D, E.

Also shown in FIG. 4 is vacuum system 480 which evacuates gases from the inside of cylinder 107.

As shown in FIG. 4, liquid enters inside channel 465 through liquid coupling 450C. Liquid coupling 450A is used to allow water to leave the inside channel 465 and to reach the water return. Valve 496 prevents water from leaving inside channel 465 via liquid couplings 400X, 400Y, 400Z, 450B.

As stated above, once the liquid reaches the liquid return, the liquid may be cooled and then returned to the liquid supply which is supplying inside channel 460, 465.

Due to the horizontal orientation shown in FIG. 4, it is desirable for cooling liquid to be fed to inside channel 460 through liquid couplings which are at the bottom of vessel 105 in the orientation shown. Thus, in FIG. 4, liquid is being fed to inside channel 460 via liquid couplings 400D, 400E, and 400G. Furthermore, in an exemplary embodiment of the present invention, liquid is being fed to inside channel 460 via liquid coupling 400C. Furthermore, liquid is leaving inside channel 460 via liquid couplings 400A, 400B, and 400F. In the exemplary embodiment of the present invention, valve switches 490, 492 and 494 are included. In the exemplary embodiment shown in FIG. 4, supply of liquid from valve switch 490 to valve switch 492 has been blocked. Valve switch 490 is permitting the liquid supply to reach liquid coupling 400G and 400E. Valve switch 494 is permitting liquid to flow out of couplings 400A, 400F and to the liquid return.

In the exemplary embodiment shown in FIG. 4, liquid is also being introduced into inside channel 465 in order to cool the outside of door 225. Liquid is flowing into inside channel 465 via liquid coupling 450C. Exit of liquid from inside channel 465 via liquid coupling 450B has been blocked (via valve 496). Liquid leaves inside channel 465 via liquid coupling 450A and is returned to liquid return.

Liquid couplings 400X, 400Y and 400Z are usable as a further exit of liquid from inside channel 460. In the configuration shown in FIG. 4, however, couplings 400X, 400Y and 400Z are all blocked, however, via valve 496.

FIG. 5 is a sectional side view which illustrates vessel 105 in a vertical configuration. As shown in FIG. 5, some liquid couplings which are performing different functions than they performed when vessel 105 is in the orientation shown in FIG. 4.

In the vertical configuration shown in FIG. 5, water is entering inside channel 460 via liquid couplings 400B, 400C, and 400D. Valve switch 490 blocks liquid from entering or leaving liquid couplings 400E, 400G. Furthermore, in the exemplary embodiment shown, valve switch 490 permits liquid to flow from valve switch 490 to valve switch 492. Valve switch 492 is configured to allow liquid to flow into liquid coupling 400B. Valve switch 494 is configured to block liquid from entering or leaving inside channel 460 via liquid couplings 400A, 400F.

Liquid introduced into inside channel 460 leaves inside channel 460 via couplings 400X, 400Y and 400Z. Liquid leaving couplings 400X, 400Y and 400Z reaches liquid return via valve switch 496.

Liquid is also introduced into inside channel 465 of door 225 via liquid coupling 450C. Liquid leaves inside channel 465 via liquid couplings 450A, 450B and is permitted to reach liquid return via valve 496.

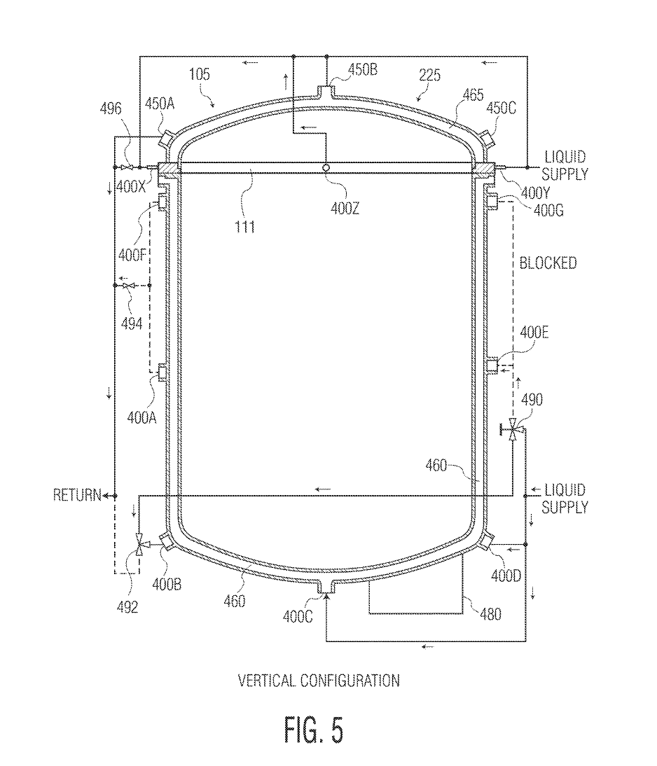

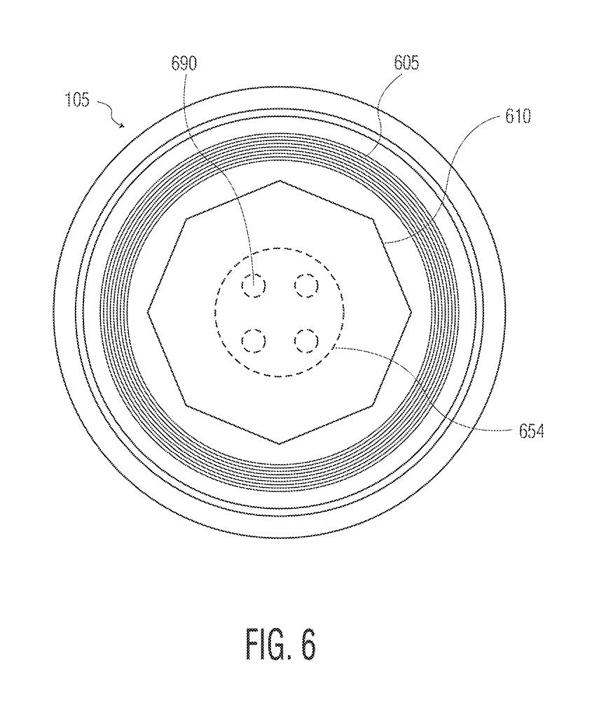

FIG. 6 is an interior view of vessel 105. Situated within vessel 105 are heating elements 610. Heating elements 610 may be electrified and the structure for accomplishing electrification is not shown in the figure. Electrification of heating elements, however, is known to one of ordinary skill in the art and is illustrated, for example, by US 2013/0175256 which is hereby incorporated by reference. Around heating elements 610 are heat reflecting shields 605. Again, heat reflecting shields are well known to one of ordinary skill in the art and are illustrated, for example, by US 2002/0126729, which is also incorporated by reference.

Inside of vessel 105, a hearth is included upon which the work piece is laid during heating. One option which may be provided is to configure the hearth so that a horizontal surface is available for supporting the work piece whether vessel 105 is in a horizontal configuration of a vertical configuration. Thus, when vessel 105 is in a vertical configuration, hearth 654 is included. Hearth 654 is shown in FIG. 6 in phantom and in FIG. 7, and comprises legs 659, flat surface 654, and bosses 661 which receive legs 659 respectively. A first area is located within vessel 105 and bosses 661 are positioned at the first area. Legs 659 may extend orthogonally from bosses 661. The first area is shown in FIG. 6 as area 690. First area 690 may be, for example, partial openings (or indentations) in the interior of vessel 105 from which bosses 661 extend. Flat surface 654 is then attached to the tops of legs 659.

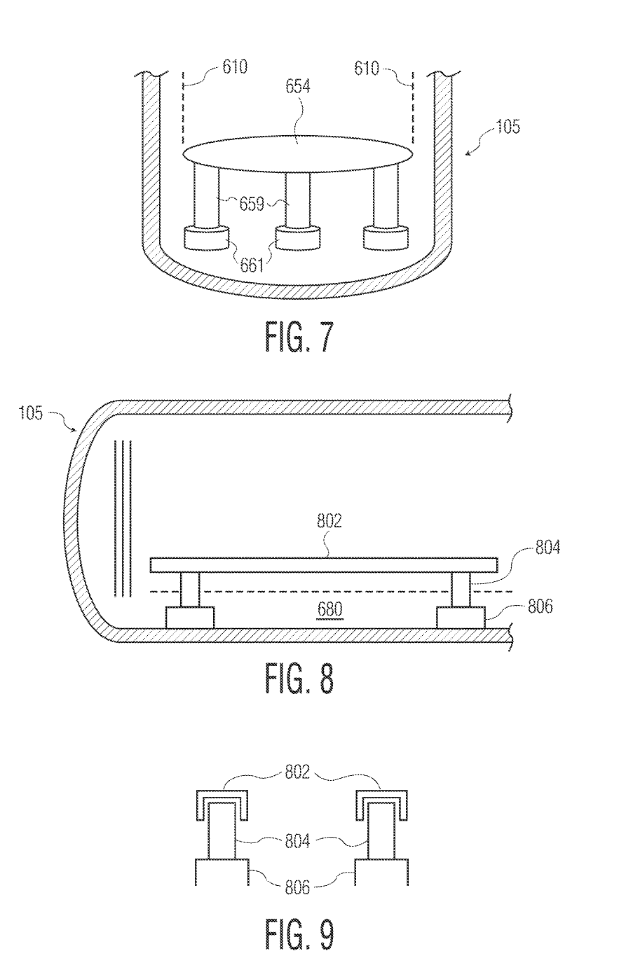

When vessel 105 is in a horizontal position as illustrated by FIGS. 8 and 9, legs 804 are positioned so they extend orthogonally from the interior surface of cylinder 107. Again, openings can be formed at a second area 680 in the interior wall of cylinder 107 and bosses 806 extend from those openings. Bosses 806 then receive legs 804 respectively. Horizontal members 802 are then attached to the tops of legs 804. The work piece is then laid on horizontal members 802. Each hearth is desirably composed of molybdenum.

In the exemplary embodiment show, vessel 105 is moved from a horizontal position to a vertical position (or from a vertical position to a horizontal position) by manually turning keyed section 310. It is understood by one of ordinary skill in the art, however, that keyed section 310 can also be rotated under motor, pneumatic or hydraulic control.

FIGS. 4 and 5 include valves 490, 492, 494 and 496. These valves may be operated by mechanical/manual control depending upon whether vessel 105 is in a horizontal or vertical configuration. Alternatively, these valves can be operated under electronic control. Furthermore, a micro-controller can adjust the configuration of valves 490, 492, 494 and 496 all at once depending upon whether vessel 105 is in a vertical orientation or a horizontal orientation.

In one exemplary embodiment, valve switches 490, 492, 494 and 496 are switched under operator controls depending upon whether vessel 105 is in a vertical or a horizontal configuration. However, it is understood by one of ordinary skill in the art that the configuration of valve switches 490, 492, 494 and 496 can be automatically established by automated measuring of the configuration of vessel 105. Thus, a proximity switch, piezoelectric device or other switch or device known to one of ordinary skill in the art can be optionally included with vessel 105 in order to generate an electric signal which indicates whether vessel 105 is in a horizontal configuration or a vertical configuration. In this manner, simply rotating vessel 105 will result in an appropriate signal being generated which in turn will provide proper control to valve switches 490, 492, 494 and 496 in order to provide liquid cooling in the manner shown, for example, by FIG. 4 and FIG. 5.

It is understood by one of ordinary skill in the art that the shape of vessel 105 and location of the liquid couplings shown are merely exemplary and can be modified as different size and heating requirements need to be met.

Operation of exemplary embodiments of the present invention will now be described.

Assuming that vessel 105 is initially in the orientation shown in FIG. 4, door 225 is opened and the work piece is inserted into vessel 105. If a hearth is not yet within vessel 105, then hearth 680 (illustrated in FIG. 8) is installed prior to the work piece being laid on hearth 680. Door 225 is then closed and locked with an appropriate locking mechanism as would be known to one of ordinary skill in the art. The interior of vessel 105 is evacuated using vacuum pump 480 and liquid is circulated through channels 460, 465 using, for example, the configuration shown in FIG. 4 (assuming liquid cooling of the exterior or cylinder 107 is being used). As the liquid circulates between liquid supply and liquid return, heating elements 610 are energized for an appropriate amount of time. After the appropriate amount of time has elapsed, heating elements 610 are de-energized and the inside of vessel 105 is allowed to cool. Cooling may be accomplished using a quenching pump (not shown). When the interior of vessel of 105 is cool enough, door 225 is opened and the work piece is removed.

If use of vessel 105 in a vertical environment is desired, vessel 105 is then rotated from the configuration shown in FIG. 4 to the configuration show in FIG. 5. Prior to rotation, if hearth 670 has been installed, hearth 670 is removed. Cylinder 105 is then rotated to the configuration shown in FIG. 5. Door 225 is opened, hearth 660 is installed, and the work piece is placed on hearth 660. Door 225 is then closed, and door 225 is locked. The interior of vessel 105 is evacuated by a vacuum pump 480, liquid is supplied to channels 460, 465 using the exemplary valve configuration shown (if liquid cooling is being used). Heating elements 610 are energized for an appropriate amount of time, and after the appropriate amount of time has elapsed, the heating elements 610 are de-energized. After the inside of vessel 105 has cooled (again, using for example, a quenching apparatus or fan which is not shown, or simply allowing the inside to cool over time), the work piece may be removed from the inside of vessel 105.

In at least one of the exemplary embodiments described above, pivoting has been described as being accomplished with the use of a pin about which rotation occurs. It is understood to one of ordinary skill in the art, however, that the above embodiments are merely exemplary, and there are other methods of facilitating rotation of vessel 105. For example, it is possible to mount vessel 105 on a curved track which extends in a vertically oriented curved path and to have vessel 105 slide along the curved path. This type of structure is described in U.S. Pat. No. 8,444,107 which is hereby incorporated by reference. Other structures are known to one of ordinary skill in the art to accomplish pivoting of an object.

While the present invention has been described herein with reference to exemplary embodiments, it should be understood that the invention is not limited thereto. Those skilled in the art with an access to the teachings herein will recognize additional modifications, applications, and embodiments within the scope thereof and additional fields in which the invention would be useful.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein, it is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A vacuum furnace, comprising:
a vessel having a door;
a plurality of heating elements within said vessel;
a pivoting member for pivoting said vessel between:
a first position where said door when closed is facing substantially upward; and
a second position where said door when closed is facing away from substantially upward;
wherein said vessel pivots relative to said pivoting member.

2. A vacuum furnace according to claim 1, wherein
a. said plurality of heating elements are situated about an axis extending along a length of said vessel,
b. in said first position said axis is substantially vertical; and
c. in said second position when said door is closed said door is facing horizontally.

3. A vacuum furnace according to claim 1, wherein said vessel includes a hollow outer wall, said vacuum furnace further comprising couplings on an outside of said vessel to an inside channel inside of said hollow outer wall.

4. A vacuum furnace according to claim 3, wherein at least one of said couplings receive liquid at what becomes a bottom of said vessel when said vessel is in said first position and at least another of said couplings receive liquid at what becomes said bottom of said vessel when said vessel is in said second position.

5. A vacuum furnace according to claim 4, wherein at least a further one of said couplings discharge liquid out of what becomes a top of said vessel when said vessel is in said first position and at least a further other one of said couplings discharge liquid out of what becomes said top of said vessel when said vessel is in said second position.

6. A vacuum furnace according to claim 4, further comprising a switch for switching receipt of said liquid to said at least one of said couplings in said first position and to said at least another of said couplings in said second position

7. A vacuum furnace according to claim 4, wherein said door includes an outer door wall and includes at least one door coupling for receiving liquid into an inside door channel inside said outer door wall which is hollow and a further door coupling for discharging liquid out of said outer door wall.

8. A vacuum furnace according to claim 1, wherein said vessel includes first areas in a first location in an interior of said vessel for receiving a hearth in said first position of said vessel and said vessel includes second areas in a second location in said interior of said vessel different than said first location for receiving said hearth in said second position, wherein said hearth provides a horizontal surface onto which a workpiece is placeable.

9. A vacuum furnace according to claim 4, further comprising a switch for switching liquid from entering said inside channel via said at least one of said couplings to entering said inside channel via said at least another of said couplings.

10. A vacuum furnace according to claim 1, further comprising an opening for evacuating gasses from said vacuum furnace.

11. A method of enabling heating of a vacuum furnace, said method comprising the steps of:
providing a vessel having a door, heating elements within said vessel, and an opening for coupling to said vessel a vacuum system for evacuating an interior of said vessel; permitting said vessel to pivot relative to a pivoting member between
a first position where said door when closed is facing substantially upward; and
a second position where said door when closed is facing away from substantially upward.

12. A method of enabling heating of a vacuum furnace according to claim 11, wherein
said plurality of heating elements are situated about an axis extending along a length of said vessel
in said first position said axis is substantially vertical and in said second position when said door is closed said door is facing horizontally.

13. A method of enabling heating of a vacuum furnace according to claim 11, wherein said vessel includes a hollow outer wall, said vacuum furnace further comprising couplings on an outside of said vessel to an inside channel inside of said hollow outer wall.

14. A method of enabling heating of a vacuum furnace according to claim 13, wherein at least one of said couplings receive said liquid at what becomes a bottom of said vessel when said vessel is in said first position and at least another of said couplings receive said liquid at what becomes said bottom of said vessel when said vessel is in said second position.

15. A method of enabling heating of a vacuum furnace according to claim 14, wherein at least a further one of said couplings discharge said liquid out of what becomes a top of said vessel when said vessel is in said first position and at least a further other one of said couplings discharge said liquid out of what becomes said top of said vessel when said vessel is in said second position.

16. A method of enabling heating of a vacuum furnace according to claim 14, further comprising the step of allowing switching receipt of said liquid to said at least one of said couplings in said first position and to said another of said couplings in said second position.

17. A method of enabling heating of a vacuum furnace according to claim 11, wherein said vessel includes first areas in a first location in an interior of said vessel for receiving a hearth in said first position of said vessel and said vessel includes second areas in a second location in said interior of said vessel different than said first location for receiving said hearth in said second position, wherein said hearth provides a horizontal surface onto which a workpiece is placeable.

18. A method of operating a vacuum furnace, said method comprising the steps of:
heating a plurality of heating elements within a vessel while said vessel is in a first position;
pivoting said vessel between said first position where a door of said vessel is facing substantially upward when closed and a second position where said door of said vessel is facing away from substantially upward when closed; and
heating said plurality of heating elements within said vessel while said vessel is in said second position.

19. A method of operating a vacuum furnace according to claim 18, wherein at least one of a plurality of couplings receive liquid at what becomes a bottom of said vessel when said vessel is in said first position and at least another of said plurality of couplings to said vessel receive liquid at what becomes said bottom of said vessel when said vessel is in said second position.

20. A method of operating a vacuum furnace according to claim 19, wherein said vessel includes first areas in a first location in an interior of said vessel for receiving a hearth in said first position of said vessel and said vessel includes second areas in a second location in said interior of said vessel different than said first location for receiving said hearth in said second position, wherein said hearth provides a horizontal surface onto which a workpiece is placeable.
